(19) United States
(12) Patent Application Publication
(10) Pub. No.: US 2002/0095962 A1
(43) Pub. Date: Jul. 25, 2002

(54) Thumbturn extension assembly

(76) Inventors: Alan Doerr, Tomball, TX (US); Cheryl Kay Koskela, Santa Rosa, CA (US)

Correspondence Address: MICHAEL BEST & FRIEDRICH LLP, 3773 CORPORATE PARKWAY, SUITE 360, CENTER VALLEY, PA, 18034-8217, US

(21) Appl. No.: 09/765,999

(22) Filed: Jan. 19, 2001

(51) Int. Cl. E05B 49/00

(52) U.S. Cl. 70/278.3; 70/278.7

(57) ABSTRACT

The present invention is directed to a thumbturn assembly for an electronic lock assembly wherein a circuit board housing and microprocessor programmed for operation of the electronic lock assembly is housed in conjunction with a power source to allow programming of the lock assembly for operation using authorized electronic key mechanisms. An inside housing assembly is assembled and thereafter coupled to the inside thumbturn and cover assembly, and a thumbturn extension is provided in association with the inside housing to allow the tailpiece to engage the slot in the latch crank assembly, while concomitantly providing a female fitting to engage the inside thumbturn upon coupling of the inside thumbturn assembly and cover assembly to the inside housing assembly. Upon combining the inside thumbturn and cover assembly to the inside housing assembly, the thumbturn, thumbturn extension and tail piece rotate as one unit to throw and retract the bolt in the latch of the locking mechanism for operation.

### TECHNICAL FIELD

This invention relates to an electronic lock assembly, wherein an inside turn assembly includes a thumbturn extension assembly to accommodate electronic components, such as a microprocessor circuit board and power source.

### BACKGROUND OF THE INVENTION

In many environments, such as apartment houses, multi-family dwellings, condominiums or the like, the transient nature of residents present problems in using conventional locking mechanisms in association with a door having a latch which is operable from both sides of the door by means of a handle or the like. In such environments, keys usable to unlock conventional lockable latching mechanisms are easily replicated, thereby potentially compromising the security provided by the lockable latching mechanism. As tenants or occupants move from such an environment, a key or copy of the key can be retained, though the former tenant or occupant is no longer entitled to access thereto. Similarly, if maintenance or repair procedures require access by other personnel, maintaining security may again be compromised if keys are duplicated or not returned by the repair or maintenance personnel. Thus, security standards in such environments may require that the lock be removed in its entirety and replaced, or the lockable latching mechanism is swapped with another mechanism from another unit to ensure security. Another alternative is to have the lockable latching mechanism re-keyed such that the previous key will not operate the mechanism. In each of these situations, the replacement, re-keying or swapping of the lockable latching mechanism is costly, both in terms of expense and/or personnel resources, and presents a time consuming and inefficient process for ensuring security.

Attempts have therefore been made to provide enhanced security by providing an electronic lock which employs a programmable processor which can be programmed to only allow operation of the lock if a valid key is used. Thus, when a tenant moves from a premises, the electronic lock can simply be reprogrammed so that the old key will not operate the lock, thereby eliminating the need to replace or re-key the lock. Although electronic locks using card readers, key pads or contact activated data ports are known, various deficiencies in such electronic lock assemblies have been found, and such systems have generally been cost prohibitive or complex, thereby limiting widespread use in such environments.

### SUMMARY OF THE INVENTION

The present invention is directed to an electronic lock assembly wherein electronic components, such as a circuit board and microprocessor programmed for operation of the electronic lock assembly, are housed in conjunction with a power source. The microprocessor allows programming of the lock assembly for operation using authorized electronic key mechanisms. The circuit board and power source are housed within an inside turn assembly of the electronic lock assembly. The inside turn assembly for the electronic lock mechanism may also comprise a thumbturn to throw and retract the bolt in the lock assembly by rotation of the thumbturn. The thumbturn has an attached tailpiece which engages a slot in the latch crank assembly, wherein the thumbturn and tailpiece rotate as one unit in the inside turn assembly. To accommodate the power source, circuit board and associated electronic components, a connector from the outside housing is provided to attach to the circuit board prior to the assembly of the thumbturn associated with the inside turn assembly. The inside turn assembly is formed to include an inside housing assembly for additional components, and an inside thumbturn and cover assembly. To allow the inside housing assembly to be assembled and thereafter coupled to the inside thumbturn and cover assembly, a thumbturn extension is provided in association with the inside housing to allow the tailpiece to engage the slot in the latch crank assembly, while concomitantly providing a female fitting to engage the inside thumbturn upon coupling of the inside thumbturn assembly and cover assembly to the inside housing assembly. Upon combining the inside thumbturn and cover assembly to the inside housing assembly, the thumbturn, thumbturn extension and tail piece rotate as one unit to throw and retract the bolt in the latch of the locking mechanism for operation.

These and other aspects of the invention will become apparent from the following detailed description of the invention when considered in conjunction with the accompanying drawings.

### BRIEF DESCRIPTION OF THE DRAWINGS

FIG. 1 is a perspective exploded schematic view showing an electronic deadbolt locking mechanism according to an embodiment of the invention;

FIG. 2 is a perspective exploded schematic view showing the inside thumbturn and cover assembly, and the inside housing as well as the thumbturn extension according to the embodiment as shown in FIG. 1;

FIG. 3 is a perspective view of the outside portion of the inside housing assembly according to this embodiment of the invention;

FIG. 4 is a perspective view of the interior of the inside housing assembly as shown in FIG. 3;

FIG. 5 is a elevational view of the thumbturn extension; and

FIG. 6 is a cross sectional view of the thumbturn extension as shown in FIG. 5.

### DETAILED DESCRIPTION OF THE INVENTION

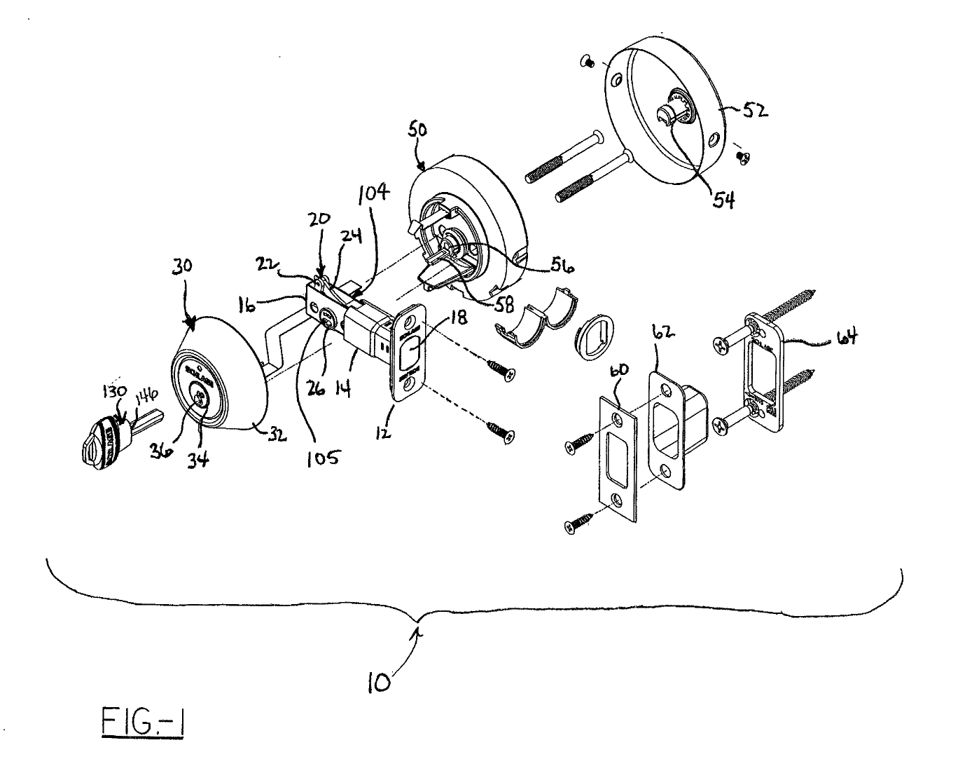

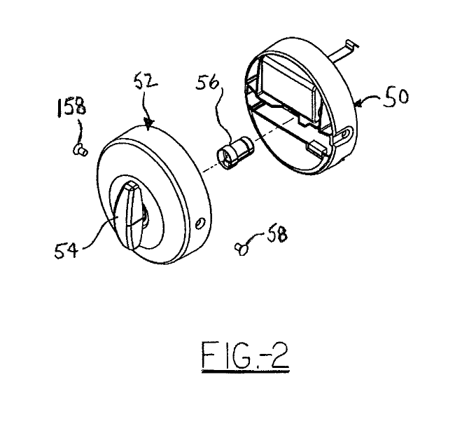

Turning now to FIG. 1, the present invention will be described in conjunction with an electronic deadbolt assembly. As shown in FIG. 1, the deadbolt assembly may include a face plate 12, which will normally be visible from the edge of the door. A front case 14 may be joined to the front plate 12, and a rear case 16 is provided in telescopic adjustable relationship to the front case 14. A deadbolt 18 is provided in slideable relationship within the front case 14, and is coupled to latch crank assembly 104 including a swivel generally indicated at 20. The swivel mechanism 20 may include a pair of ears 22 connected to a link 24. The link 24 is connected to the bolt 18 in a suitable fashion, and operation of the deadbolt 18 between a fully extended position and a retracted position is provided by means of a spindle 26 in a known fashion. In general, spindle 26 is engaged between inner and outer cylinders, wherein upon rotation of the cylinders, spindle 26 rotates to cause corresponding movement of the swivel 22 and link 24 and movement of bolt 18 between extended and retracted positions. The structures of the front case 14, rear case 16 and operation of the deadbolt is typical, and details of this construction and operation may be modified in accordance with known mechanisms.

The deadbolt assembly 10 as shown in FIG. 1 further comprising an outside housing assembly 30, which includes an outside rose 32 and a lock cylinder or cylinder plug 34, which will be described in more detail hereafter. The cylinder plug 34 includes a keyway 36, into which an electronic key 40 is inserted for operation of the deadbolt assembly 10. The deadbolt assembly 10 further comprises an inside turn assembly generally designated 50, over which an inside rose 52 is positioned. A thumbturn 54 engages the inside turn assembly 50 in a known manner, such that operation of the thumbturn 54 coupled to the inside turn assembly 50, and more particularly to a thumbturn extension 56 having an outwardly extending portion 58 which engages spindle 26 in the deadbolt assembly. Thus, upon rotation of the thumbturn 54 on the interior of the door, rotation of the thumbturn 54 will in turn cause rotation of thumbturn extension 56 and extending portion 58 so as to operate spindle 26 causing corresponding extension or retraction of the deadbolt 18 in a known fashion. The deadbolt 18 in its extended position engages a strike 60 positioned on the door jam, and an associated strike box 62. A strike reinforcer 64 may be provided to enhance the structural integrity and security of the deadbolt latch.

It should be recognized that operation of a thumbturn 54 in conjunction with the inside turn assembly 50 to selectively extend or retract the deadbolt 18 is generally known, and will not be described further.

In the electronic lock assembly as shown in FIG. 1, the inside turn assembly is comprised of an inside housing assembly 50, an inside cover assembly 52 and a thumbturn extension 54. The inside cover assembly 52 includes a thumbturn 54, which is used to selectively throw and retract the bolt 18 for selective locking and unlocking in association with the strike plate 104. The thumbturn 54 is therefore selectively rotatable by a user to operate the lock assembly. The inside cover assembly 52 provides an aesthetically pleasing inside appearance for the lock assembly, and is adapted to encompass the inside housing assembly 50 mounted in association with the lock assembly on the inside of the door, and is attached to the inside housing assembly 50 simply be means of screws 158 on either side of the cover 52 for improved aesthetics.

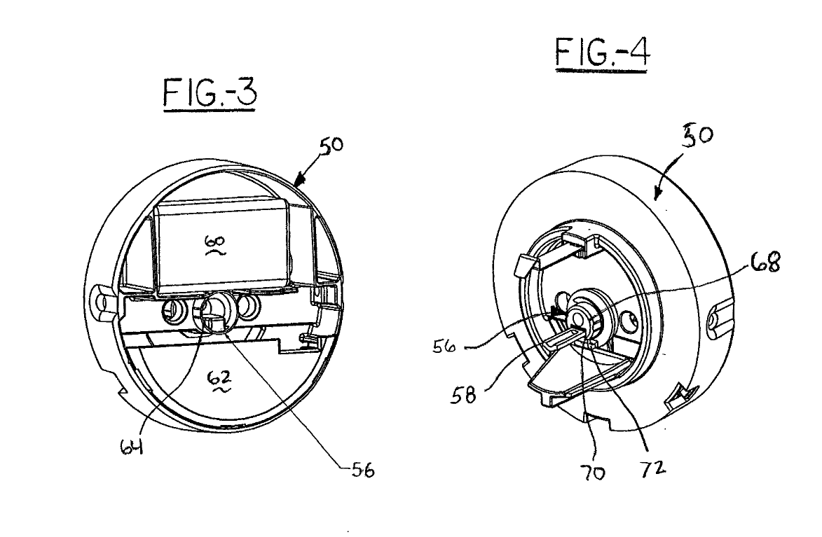

The inside housing assembly 50 is shown in more detail in FIGS. 3 and 4, and is adapted to house a number of components for use in the electronic lock assembly. As shown in FIG. 3, a battery power source compartment 60 is provided to house a battery, such as a 9 volt battery, for operation of the electronic deadbolt. The housing 50 also includes a circuit board compartment 62 for housing an electronic circuit board including a microprocessor, which is programmable to allow selected operation of the electronic deadbolt. The battery compartment 60 is selectively accessible to the user by removal of the inside cover assembly 52, allowing simple replacement of the battery power source when needed.

To accommodate a battery power source, circuit board and associated electronic components, the inside housing assembly is provided as a separate assembly to facilitate assembly of the electronic lock assembly by the user. The inside housing assembly 50 can be preconstructed with the electronic circuit board and associated components installed therein, as well as provided with a battery power source, to allow the user to more simply install the system in association with a door. The provision of the inside housing assembly 50 for housing these additional components was thus separated from the inside thumbturn assembly, to allow connection of the inside housing assembly 50 with a connector from the outside housing 104, needed to attach to the circuit board prior to assembly of the inside cover assembly 52 and associated thumbturn therewith. Thereafter, the thumbturn and inside cover assembly 52 can be easily installed over the inside housing assembly 50 to complete assembly of the lock mechanism with the door.

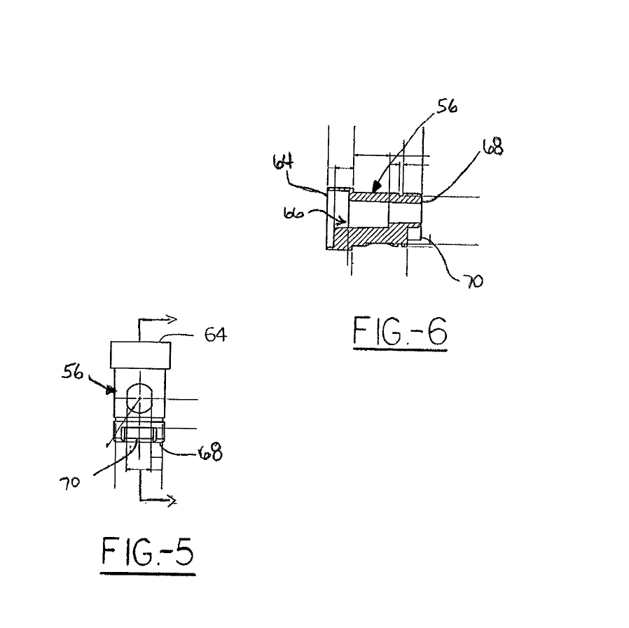

To accommodate the additional components of the circuit board, associated electronic components and battery power source, the inside housing assembly 50 has a width which will extend from the inside face of the door. To then allow engagement of the thumbturn 54 to provide the function of the inside turn assembly for throw and retraction of the deadbolt 18 in the latch by rotation of the thumbturn 54, the thumbturn extension 56 is assembled in conjunction with the inside housing assembly 50 as shown in FIGS. 3 and 4. As seen in FIGS. 5 and 6, the thumbturn extension 56 includes an outwardly facing portion having a circular opening 64 adapted to engage the thumbturn 54 associated with the inside cover assembly 52. Within opening 64 is a female fitting 66, which engages a corresponding male fitting provided in association with the thumbturn 54, such that when the inside cover assembly 52 is assembled to the inside housing assembly 50, the thumbturn 54 will engage the thumbturn extension 56. Upon rotation of the thumbturn 54, corresponding rotation of the thumbturn extension 56 will occur. The thumbturn extension 56 further includes an inward facing end 68 having a notch 70 adapted to engage an attached tailpiece 72 of extending portion 58 associated with the inside housing assembly 50 as seen in FIG. 4. The attached tailpiece 72 engages a slot 105 in the latch crank assembly 104 as previously described, such that rotation of the tailpiece 72 will operate the latch crank assembly to throw and retract the deadbolt 18 in the desired manner. Coupling of the thumbturn extension 56 to the tailpiece 72 by means of notch 70, and the corresponding connection of the thumbturn 54 with the thumbturn extension 56, allows simultaneous rotation of the tailpiece 72 upon rotation of the thumbturn 54 in the desired manner. Thus, upon operating thumbturn 54, the tailpiece 72 will rotate to cause deadbolt throw and retraction, while accommodating the battery, circuit board and associated electronic components of the electronic lock assembly.

The present invention provides simplified initial construction and assembly of the electronic lock mechanism to facilitate housing electronic components of the mechanism. The installation of the lock mechanism is then simplified by provision of the inside housing assembly 50 and separate inside cover assembly 52, while providing operative connection between a thumbturn 54 and a tailpiece 72 for operation of the deadbolt mechanism from the inside of a door. This construction provides easy installation by a user, while providing aesthetically pleasing appearance and desired operational functions.

While the invention has been described in terms of a preferred embodiment for a deadbolt latch for illustration, it should be obvious to one skilled in the art that the invention is not limited to deadbolt configurations, but could also be used in other locking mechanisms as well. Further, having described the invention in terms of a particular embodiment, it should be apparent that the invention may be varied in many ways without departing from the scope and spirit of the invention. Any and all such modifications are intended to be included within the scope of the following claims:

What is claimed is:

1. A thumbturn assembly for a locking mechanism comprising,
an inside turn assembly comprising an inside cover assembly including a thumbturn for selective operation of a locking mechanism,
a thumbturn extension which mates with the thumbturn such that rotation of the thumbturn causes rotation of the thumbturn extension, and
an inside housing assembly having a tailpiece which engages a portion of the locking mechanism, the tailpiece being coupled to the thumbturn extension such that rotation of the thumbturn extension causes rotation of the tailpiece, whereby rotation of the thumbturn, thumbturn extension and tailpiece will cause operation of the locking mechanism.

2. The thumbturn assembly according to claim 1, wherein,
the inside cover assembly provides an aesthetically pleasing inside appearance for the locking mechanism, and the inside housing assembly is positioned within the inside cover assembly and attached thereto.

3. The thumbturn assembly according to claim 1, wherein,
the thumbturn comprises a first fitting and the thumbturn extension comprises a second fitting, wherein the first and second fittings mate with one another to couple the thumbturn extension to the thumbturn for rotation therewith.

4. The thumbturn assembly according to claim 3, wherein,
the first fitting is a male fitting extending inwardly toward the locking mechanism, and the second fitting is a female fitting which engages the male fitting.

5. The thumbturn assembly according to claim 1, wherein,
the thumbturn extension includes an inward facing end having a notch which engages the tailpiece of the inside housing assembly.

6. The thumbturn assembly according to claim 1, wherein the locking mechanism is an electronic locking mechanism, and the inside housing assembly houses a battery power source for the electronic locking mechanism.

7. The thumbturn assembly according to claim 1, wherein,
the locking mechanism is an electronic locking mechanism, and the inside housing assembly houses at least one electronic component of the electronic locking mechanism.

8. The thumbturn assembly according to claim 7, wherein,
the at least one electronic component is an electronic circuit board having a programmable microprocessor associated therewith.

9. The thumbturn assembly according to claim 1, wherein,
the locking mechanism is an electronic locking mechanism, and the inside locking assembly includes a battery power source compartment for housing a battery power source, the battery power source compartment being selectively accessible by removal of the inside cover assembly for replacement of the battery power source.

10. The thumbturn assembly according to claim 1, wherein,
the inside housing assembly has an opening through which the thumbturn extension is positioned to engage the tailpiece.

11. The thumbturn assembly according to claim 1, wherein the inside housing assembly includes at least one coupling portion on an inward facing portion thereof for coupling of the inside housing assembly to other portions of the locking mechanism.

12. An electronic lock assembly comprising,
an inside turn assembly having an inside cover assembly including a thumbturn which is selectively rotatable by a user to cause operation of the lock assembly, wherein the thumbturn is coupled to a thumbturn extension rotatable with the thumbturn, the thumbturn extension positioned to extend into mating engagement with a tailpiece associated with an inside housing assembly, with the tailpiece operatively engaged with the lock assembly to cause a locking latch to be thrown and retracted upon rotation thereof, wherein the inside housing assembly houses at least one electronic component of the electronic lock assembly.
